(19) United States
(12) Patent Application Publication
(10) Pub. No.: US 2019/0054754 A1
(43) Pub. Date: Feb. 21, 2019

(54) Foldable Card Assembly

(71) Applicant: Steven Peredo, Everett, WA (US)

(72) Inventor: Steven Peredo, Everett, WA (US)

(21) Appl. No.: 15/678,219

(22) Filed: Aug. 16, 2017

(51) Int. Cl. B42D 5/02; B65D 27/00; B42D 15/04; B65D 75/54

(52) U.S. Cl. CPC B42D 5/025; B65D 27/00; A45C 11/182; B65D 75/54; B42D 15/045

(57) ABSTRACT

A foldable card assembly for creating an envelope includes a panel that is selectively manipulated. The panel has a plurality of fold lines. Moreover, the panel is selectively folded along the plurality of fold lines such that the panel forms an envelope and the envelope may be mailed. The panel has a plurality of tabs and each of the tabs engages a card thereby facilitating the envelope to contain the card when the envelope is mailed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to card devices and more particularly pertains to a new card device for creating an envelope.

### BRIEF SUMMARY OF THE INVENTION

An embodiment of the disclosure meets the needs presented above by generally comprising a panel that is selectively manipulated. The panel has a plurality of fold lines. Moreover, the panel is selectively folded along the plurality of fold lines such that the panel forms an envelope and the envelope may be mailed. The panel has a plurality of tabs and each of the tabs engages a card thereby facilitating the envelope to contain the card when the envelope is mailed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a foldable card assembly according to an embodiment of the disclosure.

FIG. 2 is an exploded view of an embodiment of the disclosure.

FIG. 3 is a perspective view of an embodiment of the disclosure.

FIG. 4 is a perspective in-use view of an embodiment of the disclosure.

FIG. 5 is a top perspective in-use view of an embodiment of the disclosure.

FIG. 6 is a front perspective in-use view of an embodiment of the disclosure.

### DETAILED DESCRIPTION OF THE INVENTION

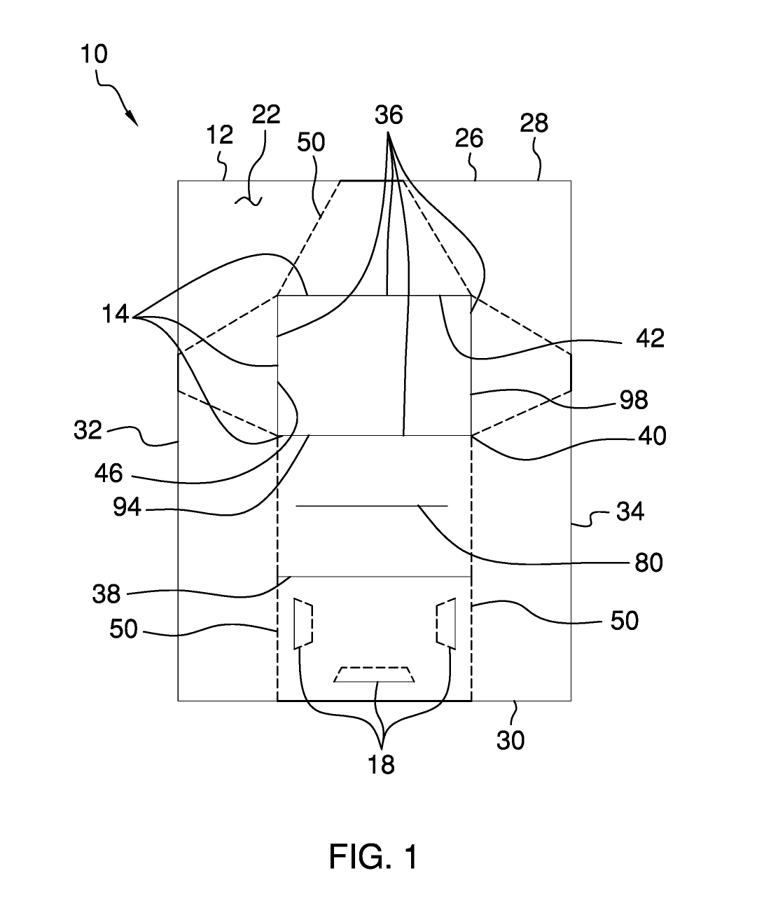

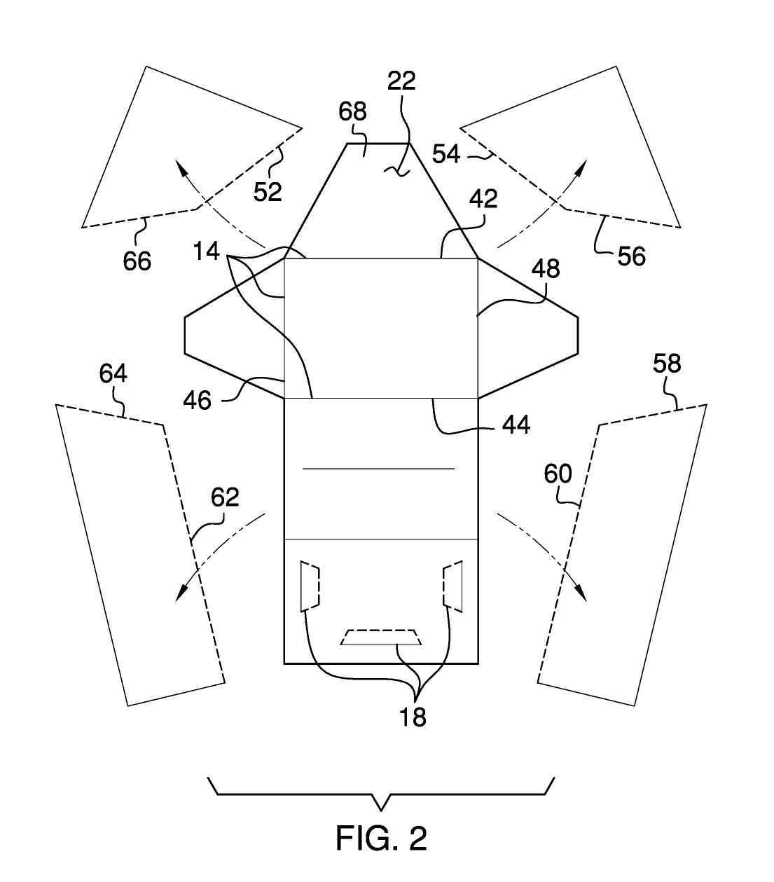

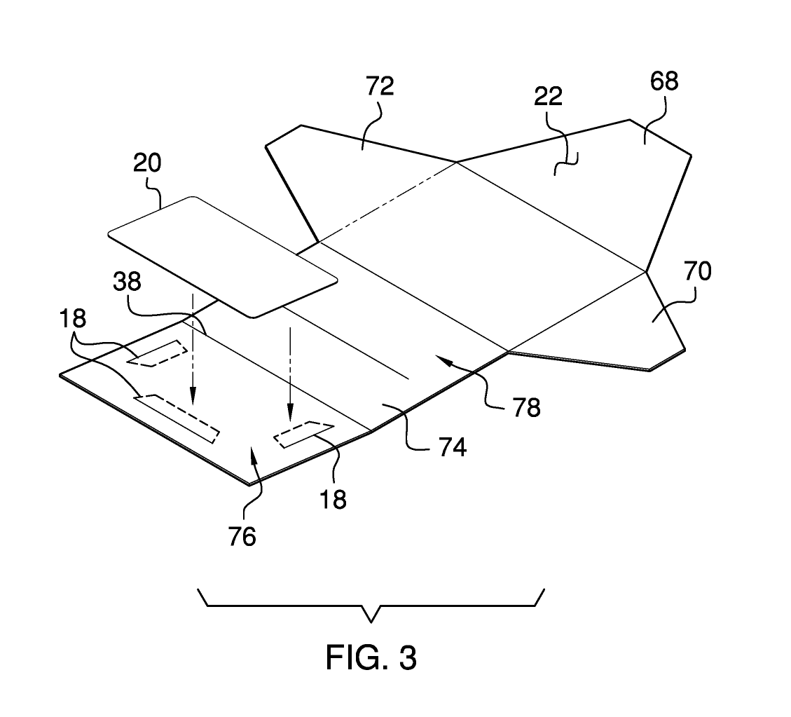

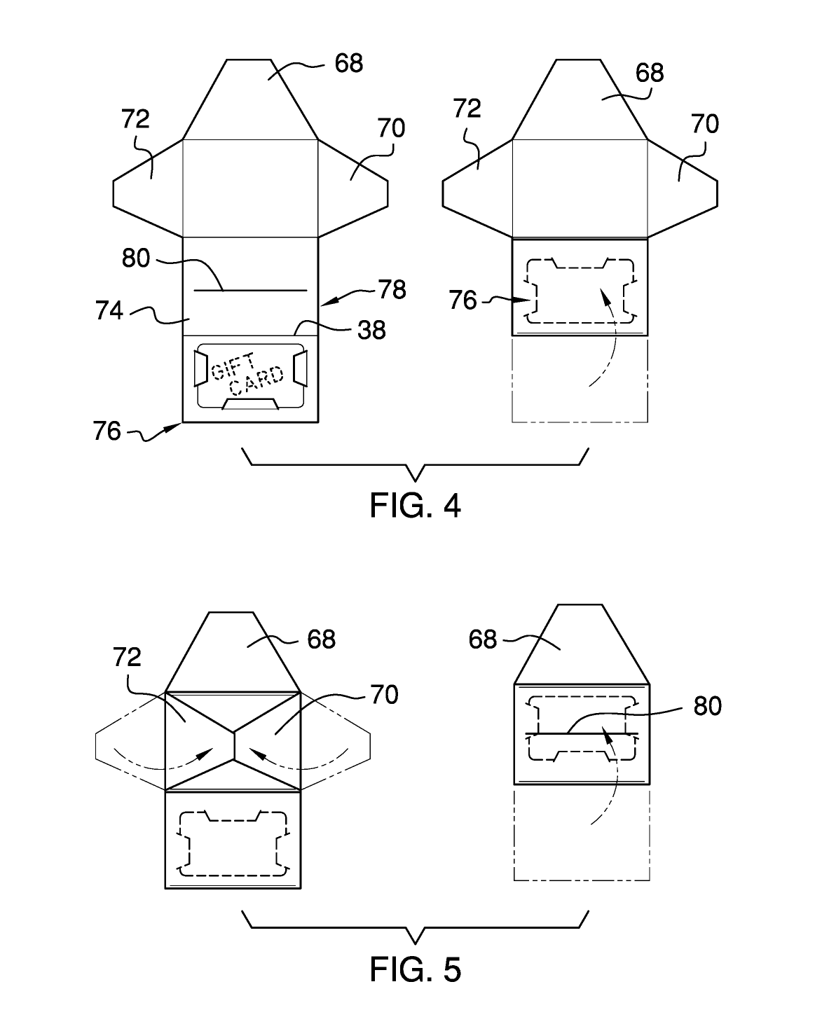

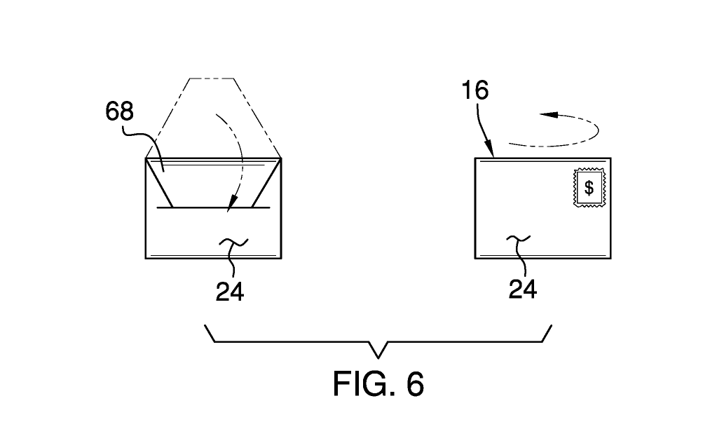

With reference now to the drawings, and in particular to FIGS. 1 through 6 thereof, a new card device embodying the principles and concepts of an embodiment of the disclosure and generally designated by the reference numeral 10 will be described.

As best illustrated in FIGS. 1 through 6, the foldable card assembly 10 generally comprises a panel 12 that is selectively manipulated. The panel 12 has a plurality of fold lines 14 and the panel 12 is selectively folded along the plurality of fold lines 14. Moreover, the panel 12 forms an envelope 16 when the panel 12 is folded thereby facilitating the envelope 16 be mailed. The panel 12 has a plurality of tabs 18 and each of the tabs 18 engages a card 20 thereby facilitating the envelope 16 to contain the card 20. The panel 12 may be comprised of a deformable material such as paper or the like and the card may be gift card or the like.

The panel 12 has a first surface 22, a second surface 24 and a peripheral edge 26 extending therebetween. The peripheral edge 26 has an upper side 28, a lower side 30, a first lateral side 32 and a second lateral side 34. The plurality of fold lines 14 includes a set of first fold lines 36 and a second fold line 38. The plurality of first fold lines 36 intersects to form a rectangle 40 that has a top side 42, a bottom side 44, a first sidelong side 46 and a second sidelong side 48. Moreover, the rectangle is offset with a center of the panel 12 and the second fold line 38 is spaced from the rectangle.

The panel 12 has a plurality of perforations 50 and each of the perforations 50 extends through the first 22 and second 24 surfaces. The plurality of perforations 50 includes a first perforation 52, a second perforation 54, a third perforation 56, a fourth perforation 58, a fifth perforation 60, a sixth perforation 62, a seventh perforation 64 and an eighth perforation 66. The first perforation 52 angles between the upper side 28 of the panel 12 and an intersection between the top side 42 and the first sidelong side 46. The second perforation 54 angles between the upper side 28 of the panel 12 and an intersection between the top side 42 and the second sidelong side 48.

The third perforation 56 angles between the first lateral side 32 of the panel 12 and an intersection between the top side 42 and the second sidelong side 48. The fourth perforation 58 angles between the first lateral side 32 of the panel 12 and an intersection between the bottom side 44 and the second sidelong side 48. The fifth perforation 60 extends between the intersection between the bottom 44 and second sidelong 48 sides and the lower side 30 of the panel 12. The sixth perforation 62 extends between the bottom 44 and first sidelong 46 sides and the lower side 30 of the panel 12. The seventh perforation 64 angles between the first lateral side 32 of the panel 12 and an intersection between the bottom 44 and the first sidelong 46 sides. Finally, the eighth perforation 66 angles between the first lateral side 32 of the panel 12 and an intersection between the upper 28 and first sidelong 46 sides.

Each of the first 52 and second 54 perforations forms a first flap 68 extending upwardly from the rectangle 40. Each of the third 56 and fourth 58 perforations forms a second flap 70 extending laterally away from the rectangle 40. Additionally, each of the seventh 64 and eighth 66 perforations forms a third flap 72 extending laterally away from the rectangle 40. Each of the fifth 60 and sixth 62 perforations forms a fourth flap 74 extending downwardly from the rectangle.

The fourth flap 74 is folded along the second fold line 38 to define a first half 76 and a second half 78 of the fourth flap 74. Each of the tabs 18 is positioned on the first half 76 of the fourth flap 74. The panel 12 has a cut 80 extending through the first 22 and second 24 surfaces and the cut 80 is positioned on the second half 78 of the fourth flap 74. Moreover, the cut 80 extends substantially between the fifth 60 and sixth 62 perforations.

In use, the panel 12 is torn along each of the plurality of perforations 50 and the card 20 is positioned in the tabs 18. The first half 76 of the fourth flap 74 is folded over onto the second half 78 of the fourth flap 74. Each of the second 70 and third 72 flaps is folded onto the first half 76 of the fourth flap 74. Continuing, the first flap 68 is folded over onto the second 70 and third 72 flaps such that the panel 12 forms the envelope 16. The first flap 68 is inserted into the cut 80 to close the envelope 16 and the envelope 16 is mailed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A foldable card assembly combining elements of a greeting card and an envelope, said assembly comprising:
a panel being configured to be manipulated, said panel having a plurality of fold lines, said panel being selectively folded along said plurality of fold lines such that said panel forms an envelope wherein said envelope is configured to be mailed, said panel having a plurality of tabs, each of said tabs being configured to engage a card thereby facilitating said envelope to contain the card.

2. The assembly according to claim 1, wherein said panel has a first surface, a second surface and a peripheral edge extending therebetween, said peripheral edge having an upper side, a lower side, a first lateral side and a second lateral side, said plurality of fold lines including a set of first fold lines and a second fold line, said plurality of first fold lines intersecting to form a rectangle having a top side, a bottom side, a first sidelong side and a second sidelong side, said rectangle being offset with a center of said panel, said second fold line being spaced from said rectangle.

3. The assembly according to claim 2, wherein said panel has a plurality of perforations, each of said perforations extending through said first and second surfaces, said plurality of perforations including a first perforation, a second perforation, a third perforation, a fourth perforation, a fifth perforation, a sixth perforation, a seventh perforation and an eight perforation.

4. The assembly according to claim 3, wherein said first perforation angles between said upper side of said panel and an intersection between said top side and said first sidelong side.

5. The assembly according to claim 3, wherein said second perforation angles between said upper side of said panel and an intersection between said top side and said second sidelong side.

6. The assembly according to claim 3, wherein said third perforation angles between said first lateral side of said panel and an intersection between said top side and said second sidelong side.

7. The assembly according to claim 3, wherein said fourth perforation angles between said first lateral side of said panel and an intersection between said bottom side and said second sidelong side.

8. The assembly according to claim 3, wherein said fifth perforation extends between said intersection between said bottom and second sidelong sides and said lower side of said panel.

9. The assembly according to claim 3, wherein said sixth perforation extends between said bottom and first sidelong sides and said lower side of said panel.

10. The assembly according to claim 3, wherein said seventh perforation angles between said first lateral side of said panel and an intersection between said bottom and said first sidelong sides.

11. The assembly according to claim 3, wherein said eighth perforation angles between said first lateral side of said panel and an intersection between said upper and first sidelong sides.

12. The assembly according to claim 3, wherein:
each of said first and second perforations forms a first flap extending upwardly from said rectangle;
each of said third and fourth perforations forms a second flap extending laterally away from said rectangle;
each of said seventh and eight perforations forms a third flap extending laterally away from said rectangle; and
each of said fifth and sixth perforations forms a fourth flap extending downwardly from said rectangle.

13. The assembly according to claim 12, wherein said fourth flap is folded along said second fold line to define a first half and a second half of said fourth flap, each of said tabs being positioned on said first half of said fourth flap, each of said tabs being configured to engage the card to retain the card on said first half of said fourth flap.

14. The assembly according to claim 13, wherein said panel has a cut extending through said first and second surfaces, said cut being positioned on said second half of said fourth flap, said cut extending substantially between said fifth and sixth perforations.

15. The assembly according to claim 14, wherein said first half of said fourth flap is folded over onto said second half of said fourth flap.

16. The assembly according to claim 15, wherein each of said second and third flaps is folded onto said first half of said fourth flap.

17. The assembly according to claim 16, wherein said first flap is folded over onto said second and third flaps such that said panel forms said envelope, said first flap being inserted into said cut to close said envelope.

18. A foldable card assembly combining elements of a greeting card and an envelope, said assembly comprising:
a panel being configured to be manipulated, said panel having a plurality of fold lines, said panel being selectively folded along said plurality of fold lines such that said panel forms an envelope wherein said envelope is configured to be mailed, said panel having a plurality of tabs, each of said tabs being configured to engage a card thereby facilitating said envelope to contain the card, said panel having a first surface, a second surface and a peripheral edge extending therebetween, said peripheral edge having an upper side, a lower side, a first lateral side and a second lateral side, said plurality of fold lines including a set of first fold lines and a second fold line, said plurality of first fold lines intersecting to form a rectangle having a top side, a bottom side, a first sidelong side and a second sidelong side, said rectangle being offset with a center of said panel, said second fold line being spaced from said rectangle, said panel having a plurality of perforations, each of said perforations extending through said first and second surfaces, said plurality of perforations including a first perforation, a second perforation, a third perforation, a fourth perforation, a fifth perforation, a sixth perforation, a seventh perforation and an eight perforation, said first perforation angling between said upper side of said panel and an intersection between said top side and said first sidelong side, said second perforation angling between said upper side of said panel and an intersection between said top side and said second sidelong side, said third perforation angling between said first lateral side of said panel and an intersection between said top side and said second sidelong side, said fourth perforation angling between said first lateral side of said panel and an intersection between said bottom side and said second sidelong side, said fifth perforation extending between said intersection between said bottom and second sidelong sides and said lower side of said panel, said sixth perforation extending between said bottom and first sidelong sides and said lower side of said panel, said seventh perforation angling between said first lateral side of said panel and an intersection between said bottom and said first sidelong sides, said eighth perforation angling between said first lateral side of said panel and an intersection between said upper and first sidelong sides, each of said first and second perforations forming a first flap extending upwardly from said rectangle, each of said third and fourth perforations forming a second flap extending laterally away from said rectangle, each of said seventh and eight perforations forming a third flap extending laterally away from said rectangle, each of said fifth and sixth perforations forming a fourth flap extending downwardly from said rectangle, said fourth flap being folded along said second fold line to define a first half and a second half of said fourth flap, each of said tabs being positioned on said first half of said fourth flap, each of said tabs being configured to engage the card to retain the card on said first half of said fourth flap, said panel having a cut extending through said first and second surfaces, said cut being positioned on said second half of said fourth flap, said cut extending substantially between said fifth and sixth perforations, said first half of said fourth flap being folded over onto said second half of said fourth flap, each of said second and third flaps being folder onto said first half of said fourth flap, said first flap being folded over onto said second and third flaps such that said panel forms said envelope, said first flap being inserted into said cut to close said envelope.
